(19) United States
(12) Patent Application Publication
(10) Pub. No.: US 2015/0212240 A1
(43) Pub. Date: Jul. 30, 2015

(54) REFLECTIVE COATINGS AND REFLECTIVE COATING METHODS

(71) Applicant: GE LIGHTING SOLUTIONS, LLC, East Cleveland, OH (US)

(72) Inventors: Dengke CAI, Willoughby, OH (US); Cherian JACOB, Brecksville, OH (US); Emily Lauren MARTIS, Cleveland, OH (US); Mark J. MAYER, Singapore Hills, OH (US); Koushik SAHA, Brunswick, OH (US); Benjamin James WARD, Beachwood, OH (US)

(73) Assignee: GE LIGHTING SOLUTIONS, LLC, East Cleveland, OH (US)

(21) Appl. No.: 14/166,395

(22) Filed: Jan. 28, 2014

(51) Int. Cl. G02B 1/14

(52) U.S. Cl. CPC G02B 1/14

(57) ABSTRACT

A reflective structure includes a polymer layer and a reflective coating applied to the plastic substrate. The reflective coating includes a first hybrid metal oxide layer, a reflective metal layer, a second hybrid metal oxide layer, and a protective coating layer.

### TECHNICAL FIELD

The technical field relates generally to reflective coatings and reflective coating methods.

### BACKGROUND

Reflective coatings are widely used in spot lighting, head lamps, roadway reflectors and the like. Such reflective coatings need to be durable and energy efficient. Energy efficiency of such reflecting structures is typically measured in the industry by reference to the lumens per watt (LPW).

### SUMMARY OF EMBODIMENTS OF THE INVENTION

The various embodiments of the present disclosure are configured to provide improved LPW and durability.

According to an exemplary embodiment, a reflective structure includes a polymer layer and a reflective coating applied to the polymer layer. The reflective coating includes a first hybrid metal oxide layer, a reflective metal layer, a second hybrid metal oxide layer, and a protective coating layer.

The foregoing has broadly outlined some of the aspects and features of the various embodiments, which should be construed to be merely illustrative of various potential applications of the disclosure. Other beneficial results can be obtained by applying the disclosed information in a different manner or by combining various aspects of the disclosed embodiments. Accordingly, other aspects and a more comprehensive understanding may be obtained by referring to the detailed description of the exemplary embodiments taken in conjunction with the accompanying drawings, in addition to the scope defined by the claims.

### DESCRIPTION OF THE DRAWINGS

FIG. 1 is a schematic illustration of a reflective structure including a plastic substrate and a reflective coating.

FIG. 2 is a flow diagram of a method of applying a reflective coating.

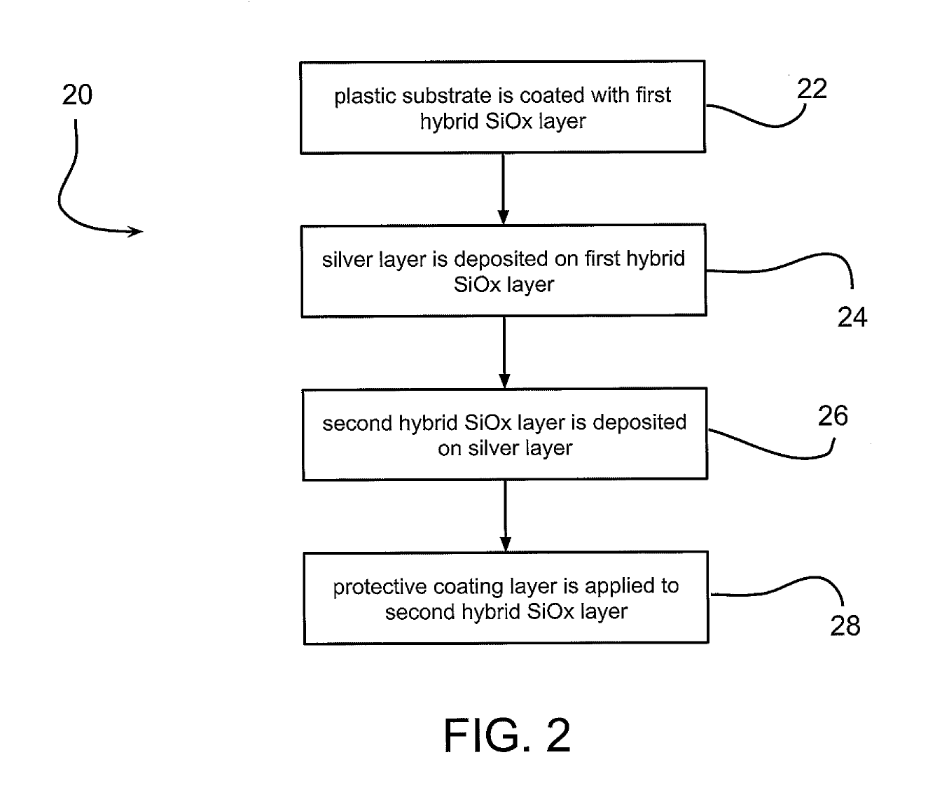

The drawings are only for purposes of illustrating preferred embodiments and are not to be construed as limiting the disclosure. Given the following enabling description of the drawings, the novel aspects of the present disclosure should become evident to a person of ordinary skill in the art. This detailed description uses numerical and letter designations to refer to features in the drawings. Like or similar designations in the drawings and description have been used to refer to like or similar parts of embodiments of the invention.

### DETAILED DESCRIPTION OF THE EMBODIMENTS

As required, detailed embodiments are disclosed herein. It must be understood that the disclosed embodiments are merely exemplary of various and alternative forms. As used herein, the word “exemplary” is used expansively to refer to embodiments that serve as illustrations, specimens, models, or patterns. The figures are not necessarily to scale and some features may be exaggerated or minimized to show details of particular components. In other instances, well-known components, systems, materials, or methods that are known to those having ordinary skill in the art have not been described in detail in order to avoid obscuring the present disclosure. Therefore, specific structural and functional details disclosed herein are not to be interpreted as limiting, but merely as a basis for the claims and as a representative basis for teaching one skilled in the art.

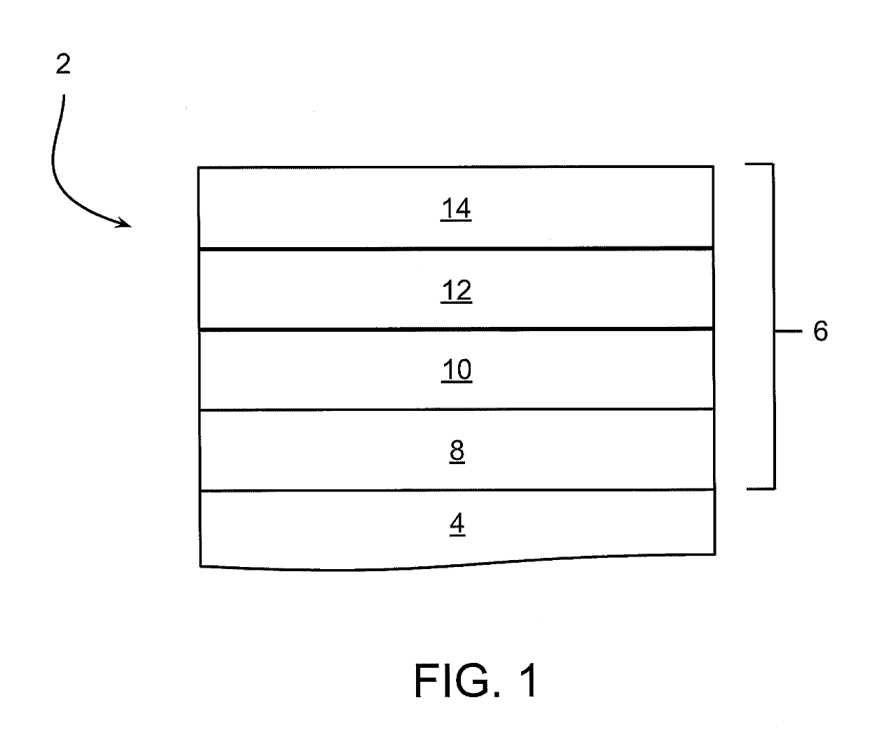

FIG. 1 is a schematic illustration of a reflective structure 2. The reflective structure 2 can be formed according to different applications. For example, the reflective structure 2 is formed as housing for an outdoor area light or as a roadway reflector. Other applications include light emitting diode (LED), incandescent lamps, halogen tungsten lamps, and other light sources such as ceramic metal halide lamps.

The reflective structure includes a polymer layer 4 and a reflective coating 6. In an exemplary embodiment described below, the polymer layer 4 is a plastic substrate 4, like Acrylonitrile Butadiene Styrene (ABS), Polycarbonate (PC), and the like. In alternative embodiments, the polymer layer includes acrylic, urethane, urethane-acrylic, polyester, silicone and the like.

The polymer layer 4 provides an interface surface of the reflective structure 2 to which the reflective coating 6 is applied. For example, the polymer layer 4 is a structure formed of plastic (e.g., an injection molded plastic reflector housing for a light) or a coating layer on a substrate or structure formed from another material such as ceramic, glass, metal, another plastic, and the like.

The reflective coating 6 is configured to reflect light sources including light emitting diodes (LEDs) laser diodes, conventional incandescent lamps, quartz metal halide lamps, and ceramic metal halide lamps, and the like, alone, or in combination and/or multiples thereof.

Moving from the inside layer of the reflective coating 6 toward the outside layer of the reflective coating 6, the reflective coating 6 includes a first hybrid metal oxide layer 8, a reflective metal layer 10, a second hybrid metal oxide layer 12, and a protective coating layer 14. The first hybrid metal oxide layer 8 provides an interface layer between the plastic substrate 4 and the reflective metal layer 10 and the second hybrid metal oxide layer 12 provides an interface layer between the reflective metal layer 10 and the protective coating layer 14.

Regarding the reflective metal layer 10, reflective metals include silver (including alloys of silver), aluminum, and the like.

With respect to the first hybrid metal oxide layer 8 and the second hybrid metal oxide layer 12, the term “hybrid” refers to an addition of organic functional groups to an inorganic metal oxide layer (e.g., two or more different metal oxides forming the same layer).

The metal oxide layer of each of the first hybrid metal oxide layer 8 and the second hybrid metal oxide layer 12 can include exemplary oxides, suboxides, carbonated compounds, and hydrogenated compounds include oxides, suboxides, carbonated compounds, and hydrogenated compounds of one or more of silicon, titanium, tantalum, zirconium, hafnium, niobium, aluminum, scandium, antimony, indium, yttrium, and the like, including silica (SiO₂), silicon monoxide, ZnO, TiO₂, Ta₂O₅, ZrO₂, HfO₂, Nb₂O₅, Al₂O₃, Sc₂O₃, Sb₂O₃, In₂O₃, Y₂O₃, titanium tantalum oxide, and non-stoichiometric oxides of these materials, combinations thereof, and the like.

Organic functional groups include X—H groups such as O—H, —C—H— —N—H, —C—F, —C-Phenyl and the like, and the other categories such as silane and siloxane groups.

The first hybrid metal oxide layer 8 is configured to promote adhesion between the plastic substrate 4 and the reflective metal layer 10. For example, the first hybrid metal oxide layer 8 reduces a mismatch between the coefficient of thermal expansion (CTE) of the plastic substrate 4 and CTE of the reflective metal layer 10 and also behaves as adhesion promotion layer between substrate 4 and reflective metal layer 10.

The second hybrid metal oxide layer 12 is configured to promote adhesion between the reflective metal layer 10 and the protective coating layer 14. For example, the second hybrid metal oxide layer 12 minimizes a mismatch between the CTE of the reflective metal layer 10 and the CTE of the protective coating layer 14.

The second hybrid metal oxide layer 12 is also configured to enhance reflectance or reflectivity of the reflective coating 6. Particularly, the thickness of the second hybrid metal oxide layer 12 (and of the protective coating layer 14) is optimized to maximize performance, as is described in greater detail below.

The protective coating layer 14 is an organic protective material. The protective coating layer 14 is resistant to mechanical failure, is able to withstand thermal stresses, and is transparent or substantially transparent in the visible region of a spectrum. The protective coating layer 14 is of sufficient thickness to protect the reflective metal layer 10 and to provide reflector performance.

Suitable protective materials for forming the protective coating layer 14 include, but are not limited to, acrylate and urethane-acrylic, siloxane such as polydimethylsiloxane (PDMS), polyester, epoxy, polyimide, and the like.

According to an exemplary embodiment, the first hybrid metal oxide layer 8 is hybrid silicon oxide (SiOx); the reflective metal layer 10 is silver (Ag); and the second hybrid metal oxide layer 12 is hybrid silicon oxide (SiOx). For this embodiment, the first hybrid metal oxide layer 8 is referred to as first hybrid SiOx layer 8, the reflective metal layer 10 is referred to as silver layer 10, and the second hybrid metal oxide layer 12 is referred to as second hybrid SiOx layer 12.

The silver layer 10 is formed entirely or predominantly from silver, such as pure silver or silver alloy. The silver layer 10 is of sufficient thickness such that light is reflected from its surface rather than transmitted therethrough. For example, the silver layer 10 has a thickness that is greater than or equal to two hundred nanometers (200 nm).

Each of the first hybrid SiOx layer 8 and the second hybrid SiOx layer 12 is a material or polymer that includes silicon oxide (SiOx) with an organic function group on the side chain or other type metal oxide grown together with an —Si—O group such as —Ti—O—Si—O—. For example, silicon oxide (SiOx) includes silicon monoxide (SiO), (SiO1.5), (SiO2-x), and the like. As mentioned above, organic functional groups include X—H groups such as O—H groups, —C—H groups, —N—H groups, other categories of functional groups such as —O—Si-Vinyl groups, and the like.

In certain embodiments, the hybrid layers have organic function groups attached to a base precursor such as R(Si(OC2H5)x). Here, R can be vinyl, phenyl, carbon fluoro groups and the like, which can be selected to adjust film refractive index, transparency, gas resistance, and mechanical properties.

In certain embodiments, a SiO2 precursor and other metal oxide precursor are blended together and, after a hydrolysis reaction, create a hybrid SiO and other metal oxide coating film. For example, SiO—TiO film, which is made from tetrabutyl titanate (Ti(OC4H9)4, TBOT) and tetraethyl orthosilicate (Si(OC2H5)4, TEOS) is illustrated as:

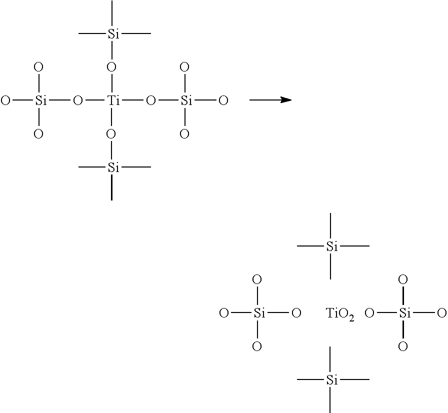

As an example, the first hybrid SiOx layer 8 includes SiOx with an —O—H functional group. SiOx with an —O—H functional group creates a Si—OH group that improves adhesion to both the silver layer 10 and the plastic substrate 4. Here, the SiO group of the first hybrid SiOx layer 8 has good adhesion with the silver of the silver layer 10 and the OH group of the first hybrid SiOx layer 8 has good adhesion with a plastic group of the plastic substrate 4. In addition, the first hybrid SiOx layer 8 includes a CTE that sufficiently matches the CTE of both silver and plastic.

As an example, the second hybrid SiOx layer 12 includes SiOx with an —O—H functional group. SiOx with an —O—H functional group creates a Si—OH group that improves adhesion to both the silver layer 10 and the protective coating layer 14. Here, the SiO group of the second hybrid SiOx layer 12 has good adhesion with the silver of the silver layer 10 and the OH group of the second hybrid SiOx layer 12 has good adhesion with an organic functional group of the protective coating layer 14.

With respect to the second hybrid SiOx layer 12, according to various embodiments, the organic functional group further includes imide, amide, C—F, phenyl, similar aromatic groups, and the like. Such organic functional groups are grown on SiOx. For example, the second hybrid SiOx layer 12 is (Ag/SiOx/-CF2-SiOx). These additional organic functional groups can be added to change the refractive index (RI) of the second hybrid SiOx layer 12 from abrupt to gradient. Particularly, the RI of the second hybrid SiOx layer 12 is changed to enhance the reflectance of the silver layer 10.

Although the RI of the second hybrid SiOx layer is changed, the SiOx remains thermally stable. For, example, SiOx remains thermally stability at temperatures below two hundred Celsius.

In addition, the thickness of the second hybrid SiOx layer 12 is selected to enhance the reflectance of the silver layer 10 by constructive interference effect. For example, the thickness of the second hybrid SiOx layer 12 is approximately one hundred and fifty nanometers.

According to an exemplary method of forming the first hybrid SiOx layer 8 and the second hybrid SiOx layer 12, polysilazane reacts with oxygen and humidity in atmosphere under heat and the product is SiO2-x. To get hybrid SiO2-x, a —SiH group in polysilazane reacts with a vinyl group attached to silicone and creates hybrid polysiloane SiO2-x. A vinyl group attached to a polysiloxane group is illustrated as:

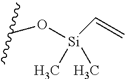 [SMILES: *O[Si](C)(C)C=C]

The reaction of —SiH with a Sivinyl group under a pt catalyst and temperature is illustrated as:

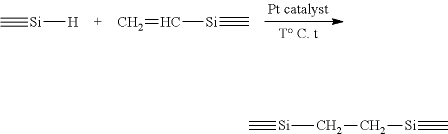

Organic groups such as —CF, —CF2, —CF3, phenyl and other organic function groups can be used in place of the methyl group (CH3) above to adjust coating properties such as reflective index, brittleness, and gas resistance.

Another way to create SiO2 film from a liquid solution is using sol-gel process. For example, a sol-gel process that creates SiO2 film is based on a precursor such as tetraethyl orthosilicate (Si(OC2H5)4, TEOS) that reacts with H2O.

The protective coating layer 14 is an organic based protective coating that contains an organic functional group. Exemplary organic-based protective coatings include acrylic, urethane, urethane-acrylic, epoxy, acrylic-epoxy, silicone, polyester and polyimide, fluoropolymer, and the like. The organic functional group of the protective coating layer 14 is selected to react with respective organic function groups of the second hybrid SiOx layer 12.

The application of a micrometer level thickness of a protective coating layer 14 protects the silver layer 10 from humidity, oxygen, and sulfide based gases.

The reflective coating 6 is applied to the plastic substrate 4 to form the reflective structure 2 according to an exemplary method 20.

According to a first step 22 of the exemplary method 20, the plastic substrate 4 is coated with first hybrid SiOx layer 8, which can be coated by a plasma enhanced chemical vapor deposition (PECVD) process. A Si—OH group of the first hybrid SiOx layer 8 reacts with the plastic substrate 4. The first hybrid SiOx layer 8 is deposited on the silver layer 10 using a precursor such as Hexamethyldisilazane (HMDS), Hexavinyldisiloxane (HVDS),silane etc.).

According to a second step 24 of the method 20, the silver layer 10 is deposited on the first hybrid SiOx layer 8. For example, a thickness of two hundred nanometers of silver is deposited. Methods of depositing silver are described below in further detail.

According to a third step 26 of the method 20, the second hybrid SiOx layer 12 is deposited on the silver layer 10.

According to a fourth step 28 of the method 20, the protective coating layer 14 is applied to the second hybrid metal oxide layer 12. Heat and ultraviolet (UV) light are applied such that the organic functional groups of the protective coating layer 14 react with organic function groups of the second hybrid SiOx layer 12. The reaction includes chemical bonding between protective coating layer 14 and the second hybrid SiOx layer 12.

Alternative methods for hybrid metal oxide layer include various other processes including chemical vapor deposition (CVD), PECVD, sol-gel, atom layer deposition (ALD), plasma polymerization, and the like.

The silver layer may be deposited by vacuum deposition methods, such as sputtering, Ion-Assisted-Deposition (IAD), physical vapor deposition (PVD), or by other known processes, such as thermal evaporation. In one embodiment, a silver target is sputtered.

The organic protective layer may be applied, for example, by similar methods in those described above. In one embodiment, a CVD process, such as a low pressure CVD process, is used. In another embodiment, PECVD, such as with a commercially-available coater, is used. Other methods include dip coating, spray coating, flow coating, and the like.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A reflective structure, comprising:
a polymer layer and a reflective coating on the polymer layer, the reflective coating, including:
a silver layer; and
a first hybrid metal oxide layer between the polymer layer and the silver reflective layer, wherein the first hybrid metal oxide layer includes a first organic functional group.

2. The reflective structure of claim 1, wherein the first organic functional group is an X—H group.

3. The reflective structure of claim 1, wherein the first hybrid metal oxide layer includes a coefficient of thermal expansion (CTE) that is between a CTE of the silver layer and a CTE of the polymer layer.

4. The reflective structure of claim 1, wherein the silver layer includes silver and at least one other metal.

5. The reflective structure of claim 4, wherein the at least one other metal is selected from a group comprising Al, Ni, and Cr.

6. The reflective structure of claim 1, the reflective coating further comprising a second hybrid metal oxide layer, wherein the second hybrid metal oxide layer includes a second organic functional group, and wherein the silver layer is between the first hybrid metal oxide layer and the second hybrid metal oxide layer.

7. The reflective structure of claim 6, wherein the second organic functional group is an X—H group.

8. The reflective structure of claim 6, wherein the second organic functional group is configured to change a refractive index of the second hybrid metal oxide layer.

9. The reflective structure of claim 6, the reflective coating further comprising a protective coating layer, wherein the second hybrid metal oxide layer is between the silver layer and the protective layer.

10. The reflective structure of claim 9, wherein the protective layer includes an organic functional group.

11. The reflective structure of claim 6, wherein the polymer layer is a plastic layer, the a first hybrid metal oxide layer is a first hybrid SiOx layer, and the second hybrid metal oxide layer is a second hybrid SiOx layer.

12. A method of applying a reflective coating, comprising:
depositing a first hybrid metal oxide layer on a polymer layer, wherein the first hybrid metal oxide layer includes a first organic functional group; and
depositing a silver layer on the first hybrid metal oxide layer.

13. The method of claim 12, wherein the first organic functional group is an X—H group.

14. The method of claim 12, comprising depositing a second hybrid metal oxide layer on the silver layer, wherein the second hybrid metal oxide layer includes a second organic functional group.

15. The method of claim 14, wherein the second organic functional group is an X—H group.

16. The method of claim 14, comprising depositing a protective coating layer on the second hybrid metal oxide layer.

17. The method of claim 16, wherein the protective coating layer includes an organic functional group.

18. The method of claim 17, wherein at least one of heat and ultraviolet light is applied such that the organic functional group of the protective coating layer and the organic functional group of the second hybrid metal oxide layer react with one another.

19. The method of claim 18, wherein the reaction includes chemical bonding between the protective coating layer and the second hybrid metal oxide layer.

20. The method of claim 14, wherein the polymer layer is a plastic layer, the a first hybrid metal oxide layer is a first hybrid SiOx layer, and the second hybrid metal oxide layer is a second hybrid SiOx layer.
